(19) United States
(12) Patent Application Publication
(10) Pub. No.: US 2026/0170150 A1
(43) Pub. Date: Jun. 18, 2026

(54) SYSTEMS AND METHODS FOR CODE INSURANCE POLICY FOR AI GENERATED CODE

(71) Applicant: The Code Insurance Company, Wayne, PA (US)

(72) Inventor: Michael M. Carter, Wayne, PA (US)

(21) Appl. No.: 19/415,705

(22) Filed: Dec. 10, 2025

Related U.S. Application Data
(60) Provisional application No. 63/705,795, filed on Oct. 10, 2024.

(51) Int. Cl. G06F 21/57; G06Q 40/08

(52) U.S. Cl. CPC G06F 21/577; G06Q 40/086; G06F 2221/033

(57) ABSTRACT

The present invention provides a system for evaluating security and vulnerabilities of source code, the system comprising at least one memory storing computer-executable instructions, and at least one processor in communication with the at least one memory, wherein the at least one processor is configured to execute the computer-executable instructions to receive, from a database, source code, scan the source code and determine if the source code contains at least one of one or more issues or one or more warnings, determine, based on the scan, a security score for the source code; and cause to be displayed, on a user interface, an interactive dashboard displaying an indication representing the security score for the source code and an explanation of the security score.

### FIELD OF THE INVENTION

The present invention relates to a method and system for identifying risk in software code libraries and creating derisking products for same.

### BRIEF SUMMARY OF THE INVENTION

In an exemplary embodiment, systems and methods may be provided for the risk evaluation of deployed software code and an automatically generated insurance policy covering at least part of the identified risk.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 illustrates a document analysis (DA) system in accordance with an exemplary embodiment of the present disclosure;

FIG. 2 illustrates an exemplary client computing device that may be used with the DA system illustrated in FIG. 1;

FIG. 3 illustrates an exemplary server system that may be used with the DA system illustrated in FIG. 1;

FIG. 4 illustrates an embodiment of the present invention;

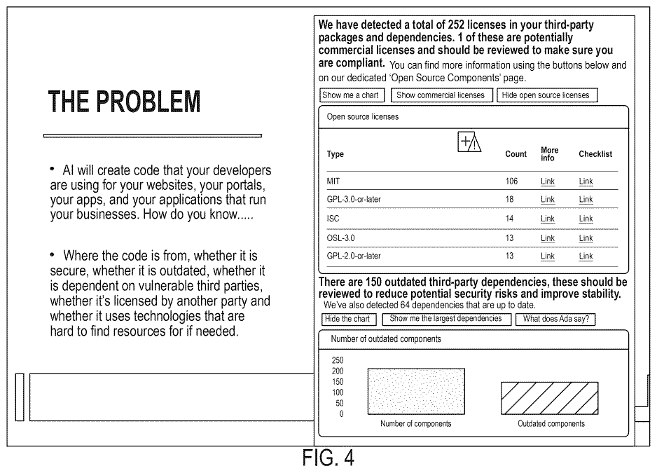

FIG. 5 illustrates an embodiment of the present invention;

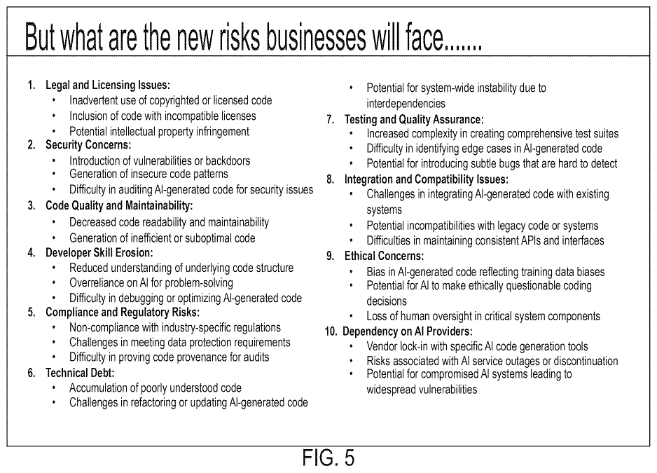

FIG. 6 illustrates an embodiment of the present invention;

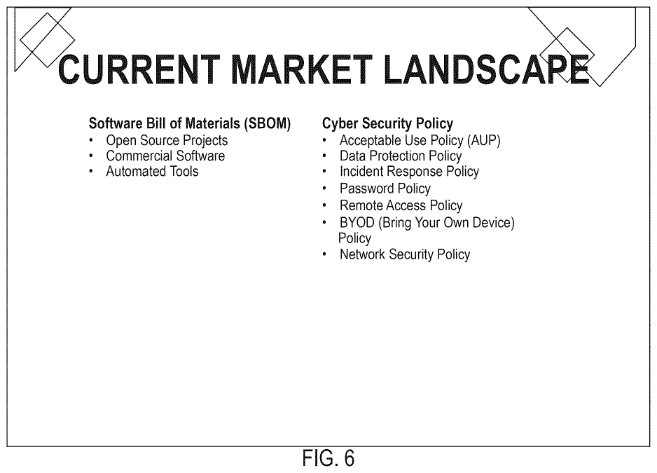

FIG. 7 illustrates an embodiment of the present invention;

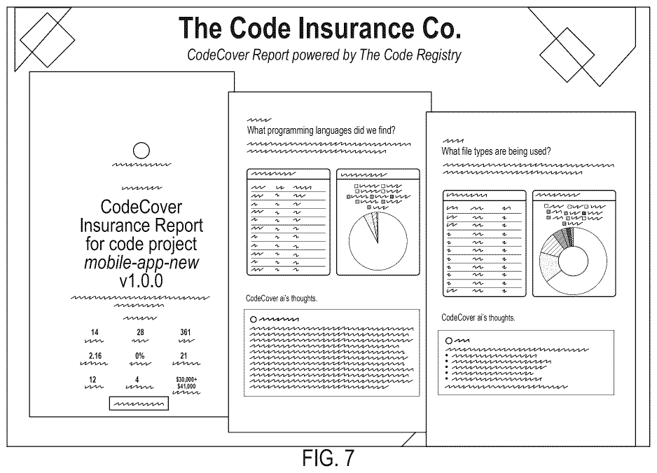

FIG. 8 illustrates an embodiment of the present invention;

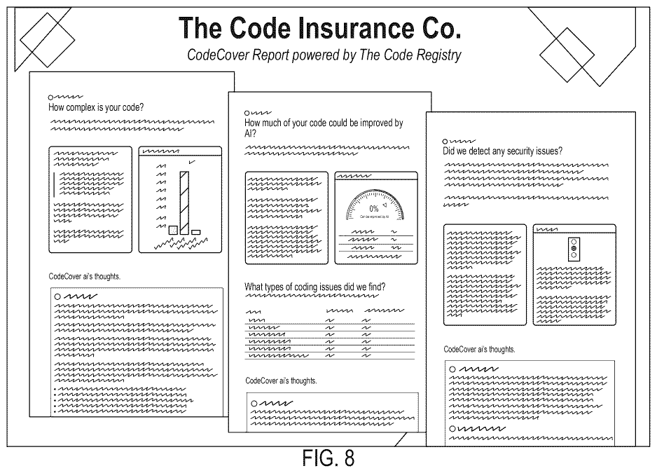

FIG. 9 illustrates an embodiment of the present invention;

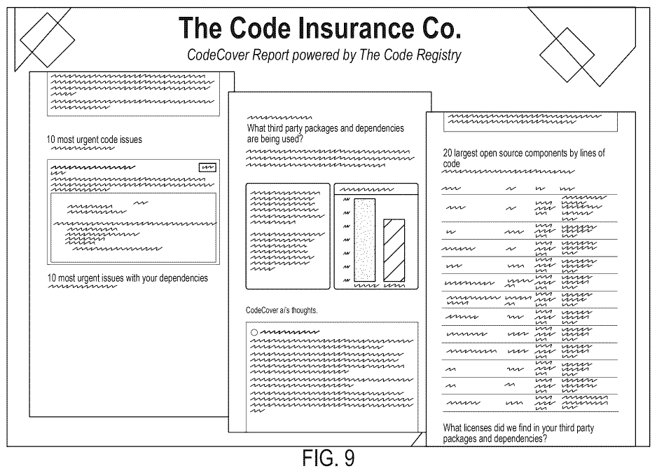

FIG. 10 illustrates an embodiment of the present invention;

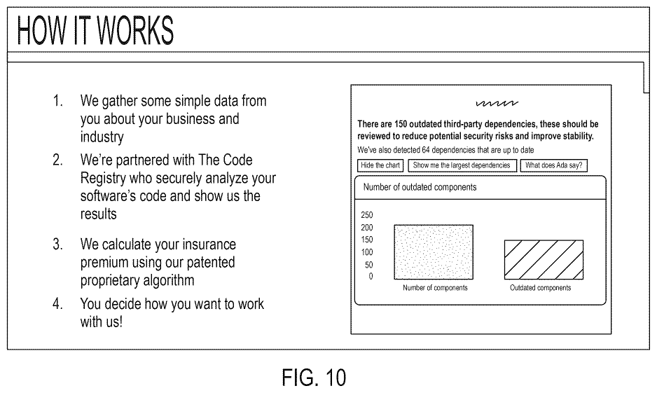

FIG. 11 illustrates an embodiment of the present invention;

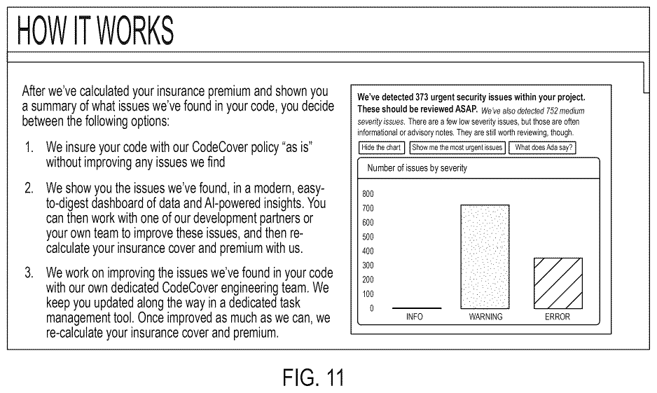

FIG. 12 illustrates an embodiment of the present invention; and

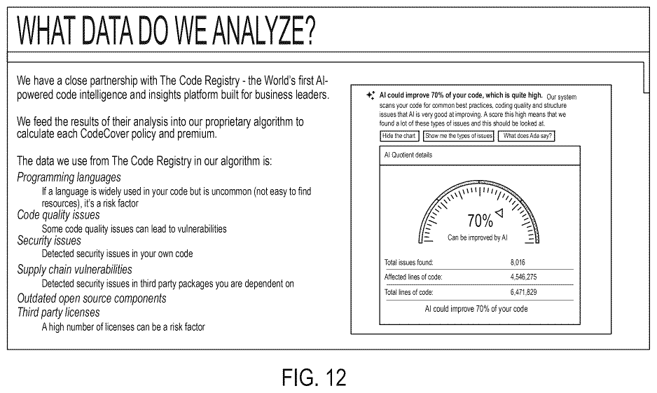

FIG. 13 illustrates an embodiment of the present invention;

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

The present embodiments may relate to systems and methods may be provided for the risk evaluation of deployed software code and an automatically generated insurance policy covering at least part of the identified risk.

Today how you would answer this question is to walk over to your CTO or Zoom him or her and wait for him or her to get you some/not all of this information. Then you would have to interface with multiple third-party systems or cloud service providers to get some of the answers. Engage IP Counsel or consultants to provide a 2-4 month IP Audit, then be handed a password to a developers code service that is made for technical developers to access and analyze the code base through a third party hub written for and by them.

So the result is that this problem is never cleanly answered. Thousands are spent to answer one third of the problem and months of time are taken to answer most of them. Then there is not one place where all stakeholders can access the same information in an easy to consume way. Thus, the present invention provides a seamless and efficient platform to help store, evaluate, replicate, and certify computer code.

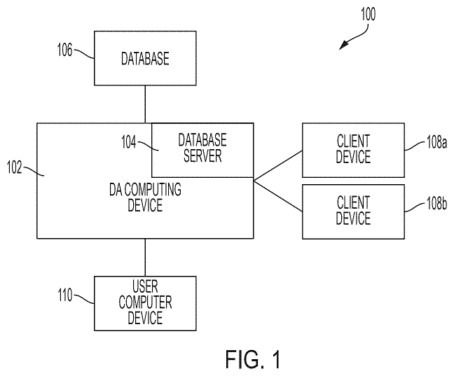

FIG. 1 depicts an exemplary artificial intelligence (AI) computing system 100. AI computing system 100 may include an AI computing device 102 (also referred to herein as AI server or AI computer device). AI computing device 102 may include a database server 104. Further, AI computing device 102 may be in communication with, for example, a database 106, one or more client devices 108a and 108b, and a client computing device, such as user computing device 110.

In the exemplary embodiments, client devices 108a and 108b may be computers that include a web browser or a software application, which enables the devices to access remote computer devices, such as AI computing device 102, using the Internet or another type of network. More specifically, client devices 108a and 108b may be communicatively coupled to AI computing device 102 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular phone connection, and a cable modem. Client devices 108a and 108b may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

User device 110 may be a computer that includes a web browser or a software application, which enables user device 110 to access remote computer devices, such as AI computing device 102, using the Internet or other network. In some embodiments, user device 110 may be associated with, or part of a computer network associated with, a medical records company. In other embodiments, user device 110 may be associated with a third party. More specifically, user device 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User device 110 may be any device capable of accessing the Internet including, but not limited to, a desktop computer, a laptop computer, a personal digital assistant (PAI), a cellular phone, a smartphone, a tablet, a phablet, wearable electronics, smart watch, or other web-based connectable equipment or mobile devices.

Database server 104 may be communicatively coupled to database 106 that stores data. In one embodiment, database 106 may include user data associated with users (e.g., personal information, medical data), prediction data, third party data, etc. In the exemplary embodiment, database 106 may be stored remotely from AI computing device 102. In some embodiments, database 106 may be decentralized. In the exemplary embodiment, a user may access database 106 and/or AI computing device 102 via client devices 108a and 108b.

### Exemplary Client Computing Device

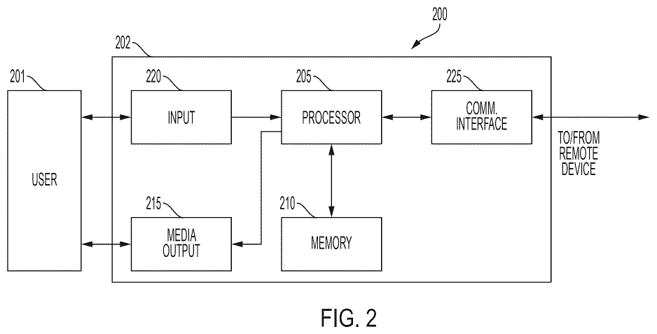

FIG. 2 illustrates a block diagram 200 of an exemplary client computing device 202 that may be used with the artificial intelligence (AI) computing system 100 shown in FIG. 1. Client computing device 202 may be, for example, at least one of devices 108a, 108b, and 110 (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In exemplary embodiments, processor 205 may include and/or be communicatively coupled to one or more modules for implementing the systems and methods described herein. For example, in one exemplary embodiment, a module may be provided for receiving data and building a model based upon the received data. Received data may include, but is not limited to, medical information data pertaining to users, medication dosage data, and/or medical treatment data pertaining to users. A model may be built upon this received data, either by a different module or the same module that received the data. Processor 205 may include or be communicatively coupled to another module for generating a OCR prediction data based upon received data pertaining to a user, such as one or more of medical diagnosis, medications, or the like.

In one or more exemplary embodiments, computing device 202 may also include at least one media output component 215 for presenting information a user 201. Media output component 215 may be any component capable of conveying information to user 201. In some embodiments, media output component 215 may include an output adapter such as a video adapter and/or an audio adapter. An output adapter may be operatively coupled to processor 205 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones). Media output component 215 may be configured to, for example, display a status of the model and/or display a prompt for user 201 to input user data.

Client computing device 202 may also include an input device 220 for receiving input from a user 201. Input device 220 may include, for example, a keyboard, a pointing device, a mouse, a stylus, a touch sensitive panel (e.g., a touch pad or a touch screen), a scanner, an image capturing device, or an audio input device. A single component, such as a touch screen, may function as both an output device of media output component 215 and an input device of input device 220.

Client computing device 202 may also include a communication interface 225, which can be communicatively coupled to a remote device, such as LP computing device 102, shown in FIG. 1. Communication interface 225 may include, for example, a wired or wireless network adapter or a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Stored in memory area 210 may be, for example, computer readable instructions for providing a user interface to user 201 via media output component 215 and, optionally, receiving and processing input from input device 220. A user interface may include, among other possibilities, a web browser or a client application. Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are exemplary only, and are thus not limiting as to the types of memory usable for storage of a computer program.

### Exemplary Server Computing Device

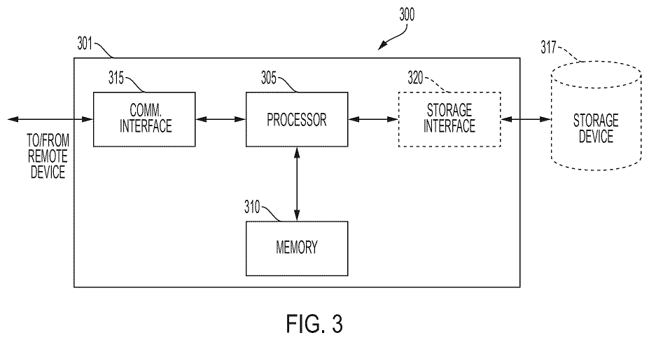

FIG. 3 depicts a block diagram 300 showing an exemplary server system 301 that may be used with the AI system 100 illustrated in FIG. 1. Server system 301 may be, for example, AI computing device 102 or database server 104 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 can communicate with AI computing device 102, client devices 108a, 108b, and 110 (all shown in FIG. 1), and/or another server system. For example, communication interface 315 may receive data from user devices 108a and 108b via the Internet.

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317. In other embodiments, storage device 317 may be external to server system 301 and may be accessed by a plurality of server systems. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer system.

In some embodiments, the systems and methods described herein may be implemented by back-end (e.g., PHP), front-end (e.g., JavaScript), scripting (e.g., BASH, and structured languages (e.g., SQL). The embodiments described are merely exemplary to provide a better understanding of the disclosed. The systems and methods described are in no way limited to these certain languages. Additionally, one or more software extensions may be used, such as Composer packages, jQuery Library, Node.js, Node modules, and Gulp for building and compiling tasks, for example. Additionally, or alternatively, a plurality of third-party services and technologies may be used, such as AWS, Setasign, Pixelcave, and hundreds of Fedora OS packages, for example. Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

Computer code replication refers to the process of duplicating or reproducing sections of code within a software program. It involves copying and pasting code snippets or entire functions to create multiple instances of the same logic in different parts of the program.

Code replication can occur for various reasons, such as code reuse, convenience, or performance optimization. However, excessive code replication can lead to several issues:

Code duplication: When the same logic is replicated across multiple places, any changes or bug fixes must be applied to each instance individually. This makes the codebase more difficult to maintain and increases the likelihood of introducing inconsistencies or errors.

Increased code size: Replicating code can result in larger codebases, leading to decreased readability and increased complexity. This can make the code harder to understand, debug, and maintain.

Reduced flexibility: If similar functionality is replicated instead of being abstracted into reusable functions or modules, it becomes harder to modify or extend that functionality in the future. Making changes in one place may require updating multiple instances, which can be time-consuming and error-prone.

Maintenance challenges: With code replication, it becomes challenging to ensure that all replicated instances are kept up to date and consistent. It can be harder to track down bugs or apply updates across multiple copies of the same code.

To mitigate these issues, software developers often strive for code reuse and modular design. By abstracting common functionality into reusable components, such as functions, classes, or libraries, they can reduce code replication and improve maintainability, readability, and overall software quality.

A computer code repository, also known as a code repository or source code repository, is a central location or storage system where developers can store, manage, and collaborate on computer code. It serves as a version control system that keeps track of changes made to the codebase over time and provides a platform for collaboration among multiple developers.

Code repositories are used to facilitate software development by offering the following features:

Version control: Code repositories enable developers to track changes to their codebase over time. They provide mechanisms to create new versions of the code, compare differences between versions, and revert to previous versions if needed. This helps manage code history, allows collaboration between developers, and provides a way to review and manage code changes.

Collaboration: Code repositories allow multiple developers to work together on the same codebase. They provide features like branching and merging, which enable developers to work on separate versions of the code and later integrate their changes. Collaboration tools such as issue tracking, comments, and pull requests facilitate communication and coordination among team members.

Backup and recovery: By storing code in a code repository, developers have a centralized backup of their codebase. In case of accidental data loss or system failures, the code can be recovered from the repository. Repositories often have backup and redundancy measures in place to ensure the safety and availability of code.

Code sharing and reuse: Code repositories provide a platform for sharing code with others. Developers can make their code public, allowing others to view, clone, and use their code in their own projects. This promotes code reuse, knowledge sharing, and collaboration within the developer community.

Commonly used code repository systems include Git (along with platforms like GitHub, GitLab, and Bitbucket), Subversion (SVN), and Mercurial. These systems offer command-line tools and web-based interfaces to interact with the code repository, manage code versions, and collaborate with other developers.

In an embodiment of the present invention, a code vault may be provided to store uploaded code. It has the ability to upload code from archives (zip/tar etc) or connect to code repositories as sources. However the code is provided, the platform will create a secure “image” of the code. This becomes the user's one true source of their IP. They can review the code in this vault and can re-upload with new code archives, or re-sync with code repositories if needed. This provides a full auditable version history with the ability to restore previous versions.

Once vaulted, users will have the ability to replicate their entire IP codebase as many times as they want. Each replication is a private, self-contained server with full root terminal access and a cloud-based code editor (Microsoft VSCode Server).

Code inside a replication can be editable, or readonly, and because each replication is a self-contained server, there's no risk that the original IP can be affected accidentally. If the IP has a web element to it (i.e. a web app, website etc) then each replication will be viewable in a browser to review/test web interfaces. Each replication may be disposable and can simply be deleted. Or a replication can become the new version of the IP (once reviewed and approved by an account manager).

This could be used for many purposes, such as: creating a new editable version of the IP that developers could be invited to work on, which can then become the new IP version after review. creating a read only version of the IP that potential investors or security analysts can review, before the replication is deleted. spinning off a version of the IP that can be changed to become a new product, without affecting the original IP. There will be a full history of all replication actions and changes.

Once vaulted and analysis processes have been run, the user will be presented with a modern interactive dashboard that can have charts and widgets for data such as: How many lines of code the IP contains; How many files, and what languages they are; If third party packages are used, what are they and are they outdated? (will have to be a supported programming language); Any known security vulnerabilities within the code from vulnerability databases; Any detected malware within the code; If the source of code was a GIT repository, how many contributors have worked on the IP and what are their stats (i.e. how many changes, most recent changes) (will depend on a supported GIT platform—i.e. github, gitlab); Potentially an analysis of coding standards and quality of code.

In an embodiment of the present invention, an analysis dashboard may be downloadable as a presentable PDF containing all of the facts.

Using a specially curated and patented valuation algorithm using various factors including the codebase and details of the business model, The present invention may give an IP a monetary valuation and may estimate how many man hours and time/cost it would take to replicate the user's IP, based on various factors.

Monetarily evaluating computer code can be a complex task, and the approach to valuation may vary depending on the specific circumstances and context. Here are a few common methods used to monetarily evaluate computer code:

Cost-based approach: This approach focuses on the cost required to develop or maintain the code. It involves evaluating the resources, time, and effort invested in creating the code. Factors such as development hours, personnel costs, software and hardware expenses, and ongoing maintenance costs are considered. This method provides a rough estimate of the value based on the expenses incurred.

Market-based approach: In this approach, the value of the code is determined by assessing the market demand and pricing for similar code or software products. Comparable sales, licensing fees, or benchmarking against similar products in the market can be used to estimate the value. This method relies on market research and analysis to determine the value based on supply and demand dynamics.

Income-based approach: This approach focuses on estimating the potential income or financial benefits that can be generated by the code. It involves evaluating factors such as projected revenue, cost savings, increased efficiency, and potential market share. This method is often used for evaluating commercial software products or codebases with revenue-generating potential.

Royalty-based approach: If the code is intended for licensing or royalty-based revenue models, this approach can be used. The value is determined by estimating the potential royalty payments or licensing fees that can be generated from the code over a specific period. Factors such as market size, expected usage, and licensing terms are considered in this approach.

The present invention may utilize an AI chatbot with a name and avatar, using the OpenAI set of APIs and the latest GPT4 model and plugin functionality. Users may be able to ask questions/tasks such as; “Who has contributed the most code on my IP?”; “What are the 3 primary languages or technologies used in my IP?”; “Please write a brief for a new development team explaining how the IP works so they can develop it further”; “What packages or languages are out of date?”; “What are the most important out of date packages which we should get fixed ASAP?”; and “Who can I talk to about selling my product?”, for example.

In an embodiment of the present invention, the IP Replication functionality may be used from third party databases, such as from Clonr, for example.

The present invention may use a service, such as, for example, the Microsoft Azure cloud. One of the driving decisions for this is that a lot of their serverless services can be “scale-to-zero” by default. Which means we can do things like create replications and servers that don't cost anyone anything when they're “idle” (not actively being used).

The present invention may have an architecture covering all of the above features. For example, the main portal website may be built with Laravel as the backend, and VueJS as the responsive frontend. It may also be hosted on Azure App Service. The database may be using an Azure MySQL server, and any files will be stored on Azure Blob Storage (Azure's version of AWS S3). Each IP vault may be a container image, stored on Azure's secure container registry using “encryption at rest” for maximum security of any IP code. Each IP code replication may use Azure's Container App service, with “scale-to-zero” configured by default.

There may be various Python functions developed using Azure Functions, which will be triggered by various events. For example once a vault is created, an analysis function will be triggered that will analyze the code for primary languages, total lines of code and more. The present invention may also use OpenAI API with the GPT4 model, and developing a ChatGPT plugin to enable the AI Assistant to consume information about the user's IP vaults and answer questions.

In an exemplary embodiment, systems and methods may be provided for the risk evaluation of deployed software code and an automatically generated insurance policy covering at least part of the identified risk.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

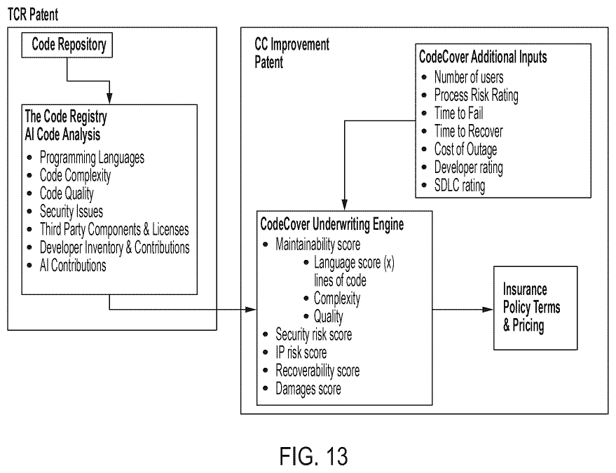

FIG. 13 depicts an exemplary insurance algorithm 1300. Insurance algorithm 1300 may examine multiple factors to determine premiums and coverage for pieces of code 1301. Such factors considered by insurance coverage 1300 may include, but are not limited to, examining; programming languages 1302, code quality issues 1303, security issues 1304, supply chain vulnerabilities 1305, outdated open-source components 1306, and third-party licenses 1307. Wherein, the code quality issues 1303, security issues 1304, and outdated open-source components will be determined utilizing some database. Thereupon, the insurance algorithm 1300 will take the resulting data and formulate the extent of a client's code that could receive coverage and the premiums with which it would charge the client for that coverage 1308.

In an exemplary embodiment, a further consideration in developing 1308 may be a monetary evaluation of the code.

FIG. 14 depicts an exemplary insurance consultation 1400. Insurance consultation 1400 may involve offering client three distinct paths in providing clients with insurance coverage. The “as is” path 1401 may involve offering the client the insurance coverage initially calculated at the initially determined rate with no further input or change. The “client-based resolution” path 1402 may involve informing the client of the flaws in their code that were detected by the exemplary algorithm 1300. The client then may alter their code on their own and resubmit the code for reevaluation by the exemplary insurance algorithm 1300. The “service-based” resolution path 1403 may involve informing the client of the flaws in their code that were detected by the exemplary algorithm 1300. The insurance company then has their own team of code engineers fix the identified issues at some rate. The code is then resubmitted to the insurance algorithm 1300 and the insurance premiums and coverage are recalculated for the client.

In an exemplary insurance consultation 1400, this process is cyclical. The insurance consultation 1400 will reoccur until the client accepts the insurance coverage through the “as is” path.

FIG. 15 depicts an exemplary insurance business model 1500. The insurance business model may begin by having clients submit their code to a code database 1501. This code database 1501 may create copies of the code that may be altered without affecting the any other existing iteration of the code. The code database 1501 may also run the code through an algorithm 1502 that may determine statistics on the quality of the code. The code may then be run through an insurance algorithm 1503. The insurance algorithm 1503 may then evaluate the code's flaws and characteristics to determine appropriate insurance premiums and coverage collected in an insurance package 1504. The insurance package 1504 may be offered to the client during an insurance consultation 1505. The insurance consultation may inquire as to whether the client would like to accept the insurance coverage 1504 without modification 1507 or whether they would like to modify a copy of the code first 1506. If the client chooses to modify a copy of the code first, then the code may be reevaluated by the insurance algorithm 1503. Steps 1503-6 may then be repeated until the client is satisfied with the insurance package 1504 and chooses to accept the insurance package 1504 without modification 1507.

AI code assessments provide a depth of code risk data not previously available through manual/human code assessments. This provides customers with an in-depth understanding of their code including a bill of materials, deficiencies, risks and remediation options. Generally, this is the end of the value proposition. Our new process and technology will leverage the depth of information available from an AI assessment (e.g. The Code Registry or similar) to produce an application specific insurance policy including inclusions, exclusions, service levels and pricing.

Quantitative inputs will largely come from the AI assessment data, our proprietary algorithms will combine these inputs to produce a risk rating.

An additional underwriting process will add qualitative factors including risks associated with the developer, the business process being served, user counts and recoverability.

As illustrated in FIG. 16, by combining in-depth AI code assessment data with more traditional underwriting, we will create a quick, lean, agile process that will produce application specific insurance policies near real-time. Today's businesses typically run on 100× the software lines of code than they did ten years ago, and it is projected by 2028 90% of all software code will be generated by AI. We believe the only way to properly protect businesses from escalating application software risk is insurance at the speed of AI enabled by our proprietary underwriting process.

This application specific, automated underwriting process, leveraging AI code assessments, may be used to enhance current E&O or cyber insurance policy writing or create application specific general liability riders or endorsements.

Preliminary scoring factors leveraging the AI code review data and manual inputs are below, these will be refined through benchmarks.

From the AI scoring:

$$programming language ( X ) lines of code ( x ) language complexity score = LS$$

[run for each language present]

$$cyclomatic complexity score = CC$$

$$total number of lines of code with issues = CI$$

$$total number of security issues ( x ) severity = SI$$

[run for each severity level]

$$total number of third - party components = TP$$

$$total number of out of date components = OC$$

$$total number of components with license risk = CR$$

$$cost to replicate code = RC$$

### Manual Inputs

$$total number of users = TU$$

$$process risk rating = PR$$

$$mean time to fail = MF$$

$$mean time to recover = RT$$

$$cost of outage = CO$$

$$developer rating = DR$$

$$SDLC score = SD$$

### Risk Rating Factors

$$LS - CC - CI - SI - TP - OC - CR - DR - SD = RR$$

### Risk Loss Factors

$$RC - TU - PR - MF - RT - CO = RL$$

### Premium Calculation

$$RR - RL = \$$$

I claim:

1. A system for evaluating security and vulnerabilities of source code, the system comprising:
at least one memory storing computer-executable instructions; and
at least one processor in communication with the at least one memory, wherein the at least one processor is configured to execute the computer-executable instructions to:
receive, from a database, source code;
scan the source code and determine if the source code contains at least one of one or more issues or one or more warnings;
determine, based on the scan, a security score for the source code; and
cause to be displayed, on a user interface, an interactive dashboard displaying an indication representing the security score for the source code and an explanation of the security score.

2. The system of claim 1, further comprising a method:
identifying for the client how the code's flaws influenced the insurance rate.

3. The method of claim 2, wherein the client is offered the opportunity to accept the coverage as is.

4. The method of claim 2, wherein the client is offered the opportunity to fix their code themselves prior to reevaluation of the insurance premiums and coverage.

5. The method of claim 2, wherein the insurance company offers a service where the client hires the insurance company's own team of software engineers to fix the code's issues prior to reevaluation.

6. The methods of claim 5, wherein the software engineers will utilize a copy of the client's code to implement their alterations without impacting the original lines of the code.

7. A method of providing insurance coverage for code, the method comprising:
analyzing a code cover report that details identified flaws in the code and its economic value;
determining then which lines of the code are worth covering; and
calculating, an insurance rate based on the value of the code and the risks associated with the code through its identified flaws.

8. The method of claim 7, wherein the economic value of the code is determined through an approach:
using a cost-based approach:
evaluating the resources, time, and effort invested in creating the code;
considering development hours, personnel costs, software and hardware expenses, and ongoing maintenance costs; and
determining a rough estimate of the value based on the expenses incurred.
using a market-based approach:
evaluating the market demand and pricing for similar code or software products;
considering sales, licensing fees, or benchmarking against similar products in the market; and
determining value based on supply and demand dynamics.
using an income-based approach:
evaluating the projected revenue, cost savings, increased efficiency, and potential market share;
considering the potential income or financial benefits that can be generated by the code; and
determining the revenue-generating potential of commercial software products or codebases.
using a royalty-based approach
evaluating market size, expected usage, and licensing terms;
considering the code's potential for licensing or royalty-based revenue models; and
determining the potential royalty payments or licensing fees that can be generated from the code over a specific period.

9. The method of claim 7 wherein the risk associated with coverage for the code is determined by evaluating:
programming languages:
considering the number of programming languages utilized, the extent to which each language is utilized, and the number of files in the code associated with each programming language.
code quality issues:
evaluating the client's code in terms of the code's overall complexity by considering the relative ease with which the code can be maintained and tested;
considering also the code's length, function complexity, and control flow; and
determining if the client's code has issues such as insecure URLs, suspicious comments, outdated OSS components, contains sensitive data in the source code, etc.
security issues:
considering known security issues associated with certain lines of the code that may exist in the client's code.
supply chain vulnerabilities:
detecting security issues in third party packages the client's code is dependent upon.
outdated open-source components:
evaluating the extent to which the code relies on such components, the effect that reliance on outdated code has on the client's code and known vulnerabilities in the open-sourced code.
third-party licenses:
evaluating the number of licenses utilized, the extent to which the code relies on the licenses, and the capability of the licenses to be replaced.
